(19) United States
(12) Patent Application Publication
(10) Pub. No.: US 2011/0161997 A1
(43) Pub. Date: Jun. 30, 2011

(54) AUDIOVISUAL PROGRAMMING SELECTION SYSTEM AND METHOD OF USE

(76) Inventor: Christopher J. Rourk, Dallas, TX (US)

(21) Appl. No.: 13/043,373

(22) Filed: Mar. 8, 2011

Related U.S. Application Data
(63) Continuation of application No. 10/107,731, filed on Mar. 26, 2002, now abandoned.
(60) Provisional application No. 60/278,463, filed on Mar. 26, 2001.

(51) Int. Cl. H04N 7/16

(52) U.S. Cl. 725/5

(57) ABSTRACT

A system for receiving audiovisual content is provided, such as for viewing a television program that is provided on demand over the Internet. The system includes a charge selection system that allows the viewer to select whether to receive the television program for free with commercials or to pay for the television program and receive it without commercials. A content viewing system connected to the charge selection system receives the viewer's selection and presenting the television show in the selected format.

### RELATED APPLICATIONS

This application claims priority to provisional U.S. Application No. 60/278,463, filed Mar. 26, 2001, entitled “AUDIOVISUAL PROGRAMMING SELECTION SYSTEM AND METHOD OF USE,” which is hereby incorporated by reference for all purposes.

### FIELD OF THE INVENTION

The present invention pertains to the field of audiovisual programming selection systems. More specifically, the invention relates to an audiovisual programming selection system and method of use that allows a user to select between receiving the content free with commercials or paying for the content to receive it commercial-free.

### BACKGROUND OF THE RELATED ART

Systems for delivering audiovisual data on demand are known in the art. Such systems typically involve pay-per-view systems, such as where a user is charged for each viewing, or free systems, such as streaming audiovisual data over the Internet. In either of these formats, the decision whether or not to charge for the content has been made prior to making the content available to the user.

Although cost limitations currently exist on the use of the Internet as a delivery mechanism for audiovisual content on a wide-spread basis, systems currently exist that allow users to request streaming video on demand. Unlike broadcast formats, where the programming is determined in advance and may be provided free of charge (typically with commercials), for a flat fee, or in a pay-per-view format, audiovisual content over the Internet can be provided on demand at all times. Therefore, the current broadcast programming formats will no longer be applicable to on-demand distribution of audiovisual content.

While on-demand audiovisual content is currently available from numerous websites, there are no systems that allow users to locate such audiovisual content on demand, so as to allow users to be aware of audiovisual content from various sources, of various genres, or according to other classifications. Therefore, users must presently spend a significant amount of time searching for audiovisual content, and might ultimately be unable to find it.

### SUMMARY OF THE INVENTION

In accordance with the present invention, an audiovisual programming selection system and method of use are provided that overcome known problems with delivering audiovisual content.

In particular, an audiovisual programming selection system and method of use are provided that allow users to select between receiving the audiovisual content for free with commercials, or paying for the content so as to receive it free of commercials.

In accordance with an exemplary embodiment of the present invention, a system for receiving audiovisual content is provided, such as for viewing a television program that is provided on demand over the Internet. The system includes a charge selection system that allows the viewer to select whether to receive the television program for free with commercials or to pay for the television program and receive it without commercials. A content viewing system connected to the charge selection system receives the viewer's selection and presenting the television show in the selected format.

The present invention provides many important technical advantages. One important technical advantage of the present invention is a system and method for providing audiovisual content that allows the user to elect whether to view it for free with commercials or to pay for the audiovisual content to receive it commercial free. The present invention also allows viewers to be provided with incentives such as prizes for viewing content, can be used to confirm whether the users are viewing the content, and allows users to select audiovisual programs for viewing based on content, how well the programs have been enjoyed by others, the cost or incentives for the program, or other suitable criteria.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for providing audiovisual content in accordance with an exemplary embodiment of the present invention;

FIG. 2 is a system diagram of a system for providing a content viewer system in accordance with an exemplary embodiment of the present invention;

FIG. 3 is a diagram of a system for allowing an audiovisual content provider to control the provision of the audiovisual content in accordance with an exemplary embodiment of the present invention;

FIG. 4 is a flowchart of a method for allowing a user to select audiovisual content in accordance with an exemplary embodiment of the present invention;

FIG. 5 is a flowchart of a method for allowing a user to select pay-as-you-go billing in accordance with an exemplary embodiment of the present invention; and

FIG. 6 is a flowchart of a method for allowing a user to select content in accordance with an exemplary embodiment of the present invention.

### DETAILED DESCRIPTION OF THE INVENTION

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

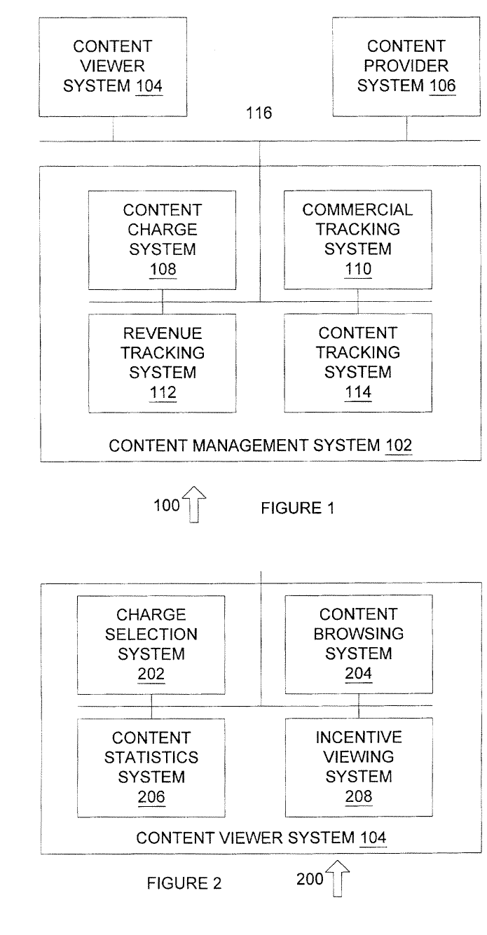

FIG. 1 is a diagram of a system 100 for providing audiovisual content in accordance with an exemplary embodiment of the present invention. System 100 allows users to locate audiovisual content of interest and to elect whether to receive that audiovisual content on a fee basis, with commercials included so as to receive the audiovisual content for free, or on other suitable bases.

System 100 includes content management system 102, which can be implemented in hardware, software, or a suitable combination of hardware and software, and which can be one or more software systems operating on a general purpose server platform. As used herein, a software system can include one or more objects, agents, threads, line of code, subroutines, separate software applications, two or more lines of code or other suitable software structures operating in two or more separate software applications, on two or more different processors, or other suitable software architectures. In one exemplary embodiment, a software system can include one or more lines of code or other suitable software structures operating in a general purpose software application, such as an operating system, and one or more lines of code or other suitable software structures operating in a specific purpose software application. In another exemplary embodiment, a software system can include one or more lines of hypertext markup language (*.HTML) or other suitable software operating in a general purpose web browser system, so as to create a specific purpose system receiving information input from a user.

Content management system 102 is coupled to content viewer system 104 and content provider system 106 over communications medium 116. As used herein, the term “couple”, and its cognate terms such as “couples” and “coupled”, can include a physical connection (such as through a copper conductor), a virtual connection (such as one or more randomly assigned memory locations of a data memory device), a logical connection (such as through one or more logical devices of a semiconducting circuit), wireless connection, other suitable connections, or a suitable combination of such connections. In one exemplary embodiment, systems and components are coupled to other systems and components through intervening systems and components, such as through an operating system of a general purpose processing platform. Communications medium 116 can be a local area network, a wide area network, the public switched telephone network, the Internet, a frame relay, a wireless network, an optical network, other suitable communications media, or a suitable combination of such communications media.

Content viewer system 104 can be implemented in hardware, software, or a suitable combination of hardware and software, and can be one or more software systems operating on a general purpose processing platform. In one exemplary embodiment, content viewer system 104 can include a video card for a general purpose processing platform that converts audiovisual data into a television signal, such as through an S video connection. Content viewer system 104 can also be a set-top box, incorporated within a standard television, or provided in other suitable configurations. Content viewer system 104 allows a user to receive content from content management system 102, content provider system 106, or other suitable systems. Content viewer system 104 allows the user to locate audiovisual content of interest, and to select a method of payment for the audiovisual content. In one exemplary embodiment, content viewer system 104 allows a user to elect to receive the audiovisual content for free, but to allow commercial content to be included with the audiovisual content. In another exemplary embodiment, content viewer system 104 can allow a user to determine whether the audiovisual content is included within a flat fee billing structure, must be paid for on a pay-per-view basis, or to determine other suitable billing or cost data for the audiovisual content.

Content provider system 106 can be implemented in hardware, software, or a suitable combination of hardware and software, and can be one or more software systems operating on a general purpose server platform. Content provider system 106 allows audiovisual content providers to control the delivery of audiovisual content to users.

Content provider system 106 can allow an audiovisual content provider to provide all audiovisual content from their premises, to transfer the audiovisual content to content management system 102 for delivery, or to select other suitable options. Content provider system 106 also allows the content provider to select the bases under which the audiovisual content shall be provided, such as with commercials, included in a flat fee arrangement, on a pay-per-view arrangement, or other suitable options.

Content management system 102 includes content charge system 108, commercial tracking system 110, revenue tracking system 112, and content tracking system 114, each of which can be implemented in hardware, software, or a suitable combination of hardware and software, and which can be one or more software systems operating on a general purpose server platform. Content charge system 108 interfaces with content viewer system 104 so as to allow a viewer to select a charging process for viewing audiovisual content. In one exemplary embodiment, content charge system 108 can generate hypertext markup language (HTML) or other suitable data that is viewed by a web browser application operating on content viewer system 104, which prompts a user to select whether to view audiovisual content for free with commercials included, on a pay-per-view basis, included in a flat fee billing structure, or in other suitable manners. For example, users can set up an account that will allow the user a predetermined amount of viewing time per period, such as where that viewing time can be allocated among any programming that the viewer wishes. Additional minutes can then be purchased at a different rate if this viewing period is exceeded. Likewise, certain audiovisual content can be priced strictly on a pay-per-view basis, such as live concerts, movies, or other suitable content. Content charge system 108 tracks these charges, and allocates charges to the user's account.

Commercial tracking system 110 is used to track commercial content that is provided to users with audiovisual content that is provided on a free basis, an incentive viewing basis, or other suitable bases. In one exemplary embodiment, commercial tracking system 110 can receive flag data or other suitable data in audiovisual content data that indicates a commercial insertion point, such that commercial tracking system 110 can insert predetermined or selected commercial content. The commercial content can be provided after the audiovisual content has been stopped, can be imbedded within the audiovisual content, provided with the audiovisual content, or in other suitable formats. Commercial tracking system 110 can also interact with content viewer system 104, can track viewer interests, can receive “cookies” or other programming devices that indicate the user's interests, or can otherwise select commercial content based upon the user's identity and interests. Commercial tracking system 110 also tracks the number of times that a user has viewed the commercial, such as to allow advertisers to purchase commercial time based on the number of views, the number of targeted views, to tie advertising revenues to subsequent purchases if a user viewing the commercial goes from the commercial to the advertiser's website to make a purchase, to prevent a user from being presented with the commercial content repeatedly so as to avoid a negative reaction to the commercial content, or other suitable options.

Revenue tracking system 112 is coupled to content charge system 108 and commercial tracking system 110 and keeps track of the number of times that audiovisual content has been viewed by content viewer system 104, the charging options under which the audiovisual content was provided, whether commercials were provided with the audiovisual content, and other suitable data. Revenue tracking system 112 then generates payment data for content provider system 106, so as to provide compensation to content provider system 106 for providing audiovisual content to viewers through content viewer system 104. Revenue tracking system 112 can also track incentive viewing programs, such as where viewers are provided with an incentive for viewing certain programs such as “infomercials,” “shopping network programs,” or other suitable content.

Content tracking system 114 interfaces with content viewer system 104, content charge system 108, and other suitable systems and tracks statistical data regarding the viewing of audiovisual content. In one exemplary embodiment, content tracking system 114 can determine the number of times that audiovisual content has been requested, the number of times that the audiovisual content has been viewed to completion, whether the audiovisual content has been requested on a fee basis or for free with commercial content, whether the audiovisual content has been provided on other cost bases, the demographic data for provision of audiovisual content (such as by age group, location in the country, time of day of delivery, background or profession of viewer, education level of viewer, or other suitable demographic data), and other suitable content tracking functionality. In this manner, content tracking system 114 can be used to determine whether viewers are losing interest in audiovisual content after a certain period of time, the demographic interest groups that shows appeal to, the pricing model that shows can generate the most revenue under, or other suitable data.

In operation, system 100 allows audiovisual content to be provided to viewers on demand in flexible formats that match the viewer's interest and abilities to pay. System 100 allows viewers that are willing to tolerate commercial content with the audiovisual content to receive such material for free. Likewise, if a viewer wishes to pay for the audiovisual content and thus provide the equivalent of advertising revenues, then system 100 allows such users to pay for audiovisual content and avoid advertising. Likewise, system 100 allows viewing plans to be offered, such that users can be given a flat rate for a certain number of minutes of viewing, and that additional minutes can then be purchased if the viewer exceeds the allotted time. Likewise, system 100 further allows audiovisual content to be provided on a pay-per-view basis, with incentive viewing, or in other suitable manners.

FIG. 2 is a system diagram of a system 200 for providing a content viewer system in accordance with an exemplary embodiment of the present invention. System 200 includes content viewer system 104 and charge selection system 202, content browsing system 204, content statistics system 206, and incentive viewing system 208, each of which can be implemented in hardware, software, or a suitable combination of hardware and software, and which can be one or more software systems operating on a general purpose computing platform.

Charge selection system 202 allows a viewer to select whether to view the audiovisual content for free with commercials, to pay for the audiovisual content on a pay-per-view basis, to use allotted minutes from a flat billing plan, or to select other suitable billing formats for the audiovisual content. Charge selection system 202 can also notify a user of the available charge options, and can further notify a user that selected content is not available for free or in a user's flat fee billing program, and that continued viewing of the content will cause the user to be charged. Charge selection system 202 can also notify the user of “free preview” periods for the audiovisual content, such as where the user can view a predetermined period of the audiovisual content, and must then decide whether to pay a fee to continue viewing the audiovisual content.

Content browsing system 204 allows a viewer to locate content by selecting from one or more categories of audiovisual content classification data, such as movie genre, sporting event type, team name, actor name, director name, game show type, music video type, or other suitable audiovisual content classification data. The user can also be provided with a limited audiovisual preview, still images from the audiovisual content, audio content, or other suitable data. Content browsing system 204 can also allow a user to select content based on the charge basis for the content, the incentive program offered for the content, other viewer's answers to subjective viewing satisfaction queries, or other suitable selection criteria. In one exemplary embodiment, content browsing system can include artificial intelligence such as a neural network that is used to select content of potential interest based on content previously viewed by the user, user demographics, content viewed by other users having related demographics, data-mined relationships between viewer demographics and viewed content, and other suitable data.

Content statistics system 206 presents content viewing statistics to the user. In one exemplary embodiment, content statistics system 206 can allow a user to see the number of viewers that have viewed the audiovisual content, the percentage of subscribers that have viewed the audiovisual content, or in other suitable data. Content statistics system 206 can also allow the user to view statistics regarding the number of viewers that have watched the content based on demographic data (such as the percentage of viewers broken down by age group, education level, profession, area of country, or other suitable criteria), the time that the user viewed the content, other audiovisual content of interest to viewers of the selected audiovisual content, or other suitable statistics.

Incentive viewing system 208 allows a viewer to receive an incentive for viewing material. Incentive viewing system 208 can “pay” a user to view material, compensate a user with product discounts, merchandise, or other similar or suitable incentives, and can be accompanied by additional functionality that confirms that the user has actually viewed the content to the end. In one exemplary embodiment, the user can receive one or more queries after completion of the audiovisual content which, if properly answered, can confirm that the user viewed the content throughout the presentation. Likewise, the user can receive periodic queries or prompts during the presentation of the content, such that if the user does not respond to the prompts or queries within a predetermined period of time, it will be assumed that the user has stopped viewing the content or is allowing the content to play without viewing, in which case the user will not receive the incentive. The user can also be provided with queries that must be answered in order to receive the incentive but which do not have a correct answer, such as a ranking of the show on a subjective scale, questions regarding things the viewer enjoyed and did not like, or other suitable data. This subjective viewing satisfaction data can then be provided to potential viewers to assist with program selection, such as through content browsing system 204. Other suitable incentive options can be implemented.

In operation, system 200 allows a user to select audiovisual content for viewing based upon price format, shared interests, or according to other suitable bases. System 200 thus provides viewers with audiovisual content in an on-demand audiovisual delivery medium where network programming does not dictate the available content.

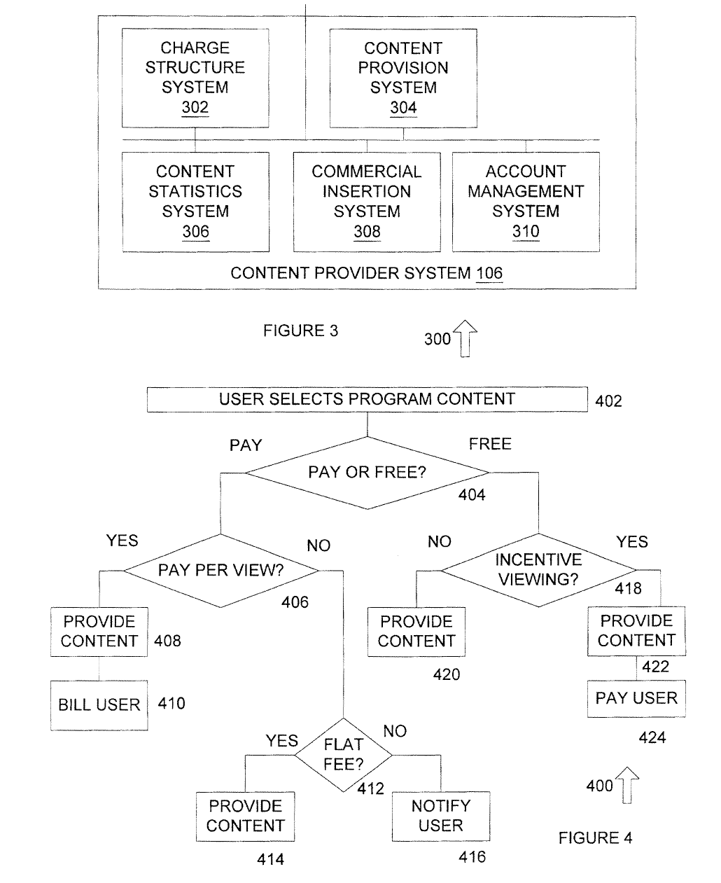

FIG. 3 is a diagram of a system 300 for allowing an audiovisual content provider to control the provision of the audiovisual content in accordance with an exemplary embodiment of the present invention. System 300 includes content provider system 106 and charge structure system 302, content provision system 304, content statistics system 306, commercial insertion system 308 and account management system 310, each of which can be implemented in hardware, software, or a suitable combination of hardware and software, in which can be one or more software systems operating on a general purpose server platform.

Charge structure system 302 allows the content provider to select a charge structure for the audiovisual content. In one exemplary embodiment, the content provider can elect whether to allow the content to be provided on a free basis with commercial insertion, to be included in conjunction with flat fee billing structures, to be provided on a pay-per-view basis only, to be provided with incentives such that viewers that watch the content will receive compensation, or on other suitable charge structures. Likewise, charge structure system 302 can allow a content provider to select the type of charge structure based upon the time of day of viewing, the demographics of the viewer, the website that the viewer is obtaining the audiovisual content from, or on other suitable options.

Content provision system 304 allows audiovisual content to be provided in a suitable format. In one exemplary embodiment, content provision system 304 allows the audiovisual content provider to control all audiovisual content provision, such as by allowing them to select the format for streaming, for direct file downloading, or other suitable formats. In this manner, a proprietary viewer format can be specified to minimize the risk that the content will be decoded and stored without permission. Likewise, content provision system 304 can interface with a content management system 102 or other suitable systems such that content provision is managed from a centralized location. In this manner, system 300 can be configured such that large-scale audiovisual streaming functionality is not required, such as a large connection bandwidth, a large number of processors, or other suitable functionality that is required to allow a large number of users to access audiovisual content on demand.

Content statistics system 306 allows a content provider to view statistics pertaining to viewing of the content provider's audiovisual content. In one exemplary embodiment, content statistics system 306 allows a content provider to determine the percentage of users that are viewing audiovisual content on a free basis with commercials, on a pay-per-view basis, in conjunction with a flat fee billing structure, or on other suitable bases. Likewise, content statistics system 306 allows the content provider to determine the number of viewers that view the content to the end, the point at which viewers stop viewing (such as to determine whether the content causes viewers to lose interest), the effect of demographic groups on such statistics (such as the number of older viewers that view the content to the end versus the number of younger viewers that view the content to the end), the effect of time of day on the content viewing statistics, and other suitable content viewing statistics.

Commercial insertion system 308 allows a content provider to specify the types of commercials that will be inserted in audiovisual and content, the locations for such commercials (such as by inserting flags or other suitable points that can be used to determine when to insert commercials), and other suitable commercial insertion data. Commercial insertion system 308 thus allows a content provider to control the amount of commercials that will be allowed, the type of commercials that will be allowed, where commercials can be provided, and other suitable parameters for commercial insertion. Commercial insertion system 308 can also be used to allocate incentives for incentive viewing, such as by randomly awarding viewers compensation or prizes, awarding “frequent viewer points,” or other suitable incentives.

Account management system 310 allows a content provider to access account information, such as to determine the revenues being generated by various types of audiovisual content, the success of advertising or incentive campaigns, or other suitable account level data. In one exemplary embodiment, account management system 310 can be used to manage large numbers of audiovisual files, such as to classify the audiovisual content into various classifications, to determine the effectiveness of various websites, advertising campaigns, or pricing schemes at generating viewers for the audiovisual data, and other suitable account management functions.

In operation, system 300 allows an audiovisual content provider to control the charge structure for the audiovisual content, the manner in which the contents is provided, and the manner in which any commercial materials are included with the audiovisual content. System 300 also allows the content provider to view statistics relating to the provision of such content and to use that statistical data to adjust the charge structure, commercial insertion data, and other suitable features of the content provision.

FIG. 4 is a flowchart of a method 400 for allowing a user to select audiovisual content in accordance with an exemplary embodiment of the present invention. Method 400 allows a user to choose the payment format for audiovisual content, and also allows statistics to be kept regarding the manner in which viewers view the audiovisual content.

Method 400 begins at 402, where a user selects program content. In one exemplary embodiment, the user can select program content by using a content browsing system 204, a content statistics system 206, an incentive viewing system 208, or other suitable systems. The method then proceeds to 404.

At 404 it is determined whether the user has selected a pay or free billing format. If a pay billing format has been selected, the method proceeds to 406, where it is determined whether the pay format is a pay-per-view format. If a pay-per-view format has been provided, the method proceeds to 408 where the content is provided. The method then proceeds to 410 where the user's account is billed. Likewise, the user can be billed on a per-minute or other periodic basis, can be billed after a predetermined amount of time has passed, or other suitable pay-per-view procedures can be implemented.

If it is determined at 406 that pay-per-view billing has not been assessed, the method proceeds to 412 where it is determined whether the program content is included within flat fee billing structures. If a flat fee billing structure has been authorized for the program content, the method proceeds to 414 where the content is provided and the time duration of the program is deducted from the time allotment for the viewer. Alternatively, if it is determined at 412 that the program content is not included within a flat fee structure, the method proceeds to 416 where the user is notified. In one exemplary embodiment, the user can be notified that the selected content is not available under the flat fee structure, and must be purchased under a pay-per-view regime. Likewise, the user can also be notified that the program content is not available under a fee structure at all, and must be viewed with commercial content included or under other suitable regimes.

If it is determined at 404 that the user has selected a free audiovisual content format, the method proceeds to 418 where it is determined whether the program qualifies for an incentive viewing format. If incentive viewing is not applicable, the method proceeds to 420 where the content is provided, such as for free, with commercials inserted, or in other suitable formats. Alternatively, if it is determined at 418 that an incentive viewing format has been authorized, the method proceeds to 422, where the content is provided to the user. The method then proceeds to 424, where the user is paid for viewing the content. In one exemplary embodiment, the user can be presented with periodic queries, can be presented with queries at the completion of the program, or other suitable procedures can be used to determine whether the viewer has viewed all of the content. Likewise, the viewer can be compensated in cash, as a credit towards programming fees, a credit toward purchasing a service or goods, viewers can be randomly selected for prizes, or compensation can be selected in other suitable manners.

In operation, method 400 allows a user to select audiovisual content for viewing and how the user shall be billed for viewing the audiovisual program content. Method 400 allows users to select to either pay for program content, to view it free with the inclusion of commercials, to be compensated with incentives for viewing the content, or in other suitable manners.

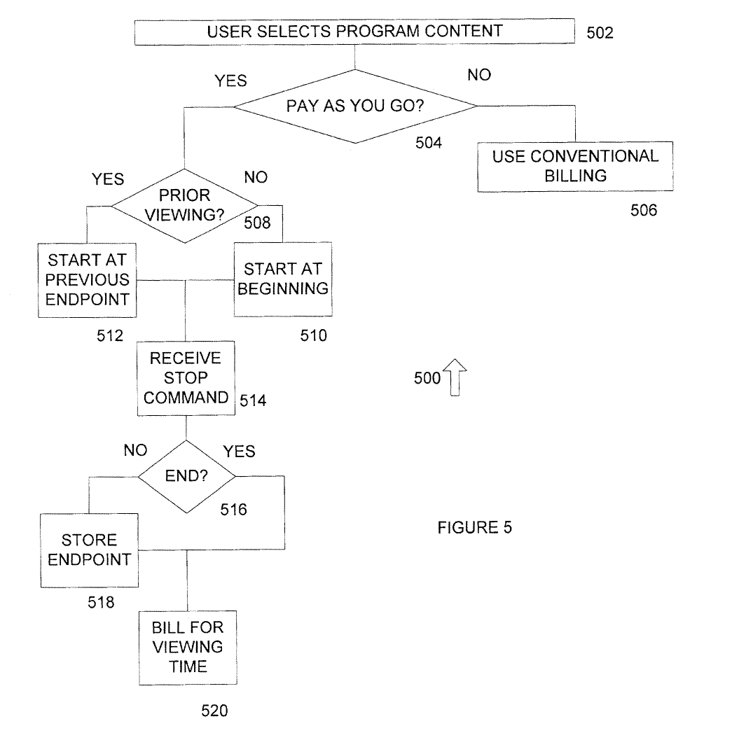

FIG. 5 is a flowchart of a method 500 for allowing a user to select pay-as-you-go billing in accordance with an exemplary embodiment of the present invention. Method 500 allows users to pay for portions of programs, to stop programs for later viewing, and to perform other suitable pay-as-you-go functions.

Method 500 begins at 502 where the user selects program content. In one exemplary embodiment, the user can select program content from a list, from classifications, from program content categories (such as type, genre, sporting event, director, actors, or other suitable categories), or in other suitable manners. The method then proceeds to 504.

At 504 it is determined whether the user has selected the pay-as-you-go format. If the user has not selected the pay-as-you-go format, the method proceeds to 506 where conventional billing is used. Otherwise, the method proceeds to 508.

At 508 it is determined whether the user has previously initiated viewing of the selected audiovisual content. If the user has previously initiated viewing, then the method proceeds to 512, where the user is provided with the option of starting at the previous end-point. In this exemplary embodiment, the user can elect to view as much or as little of a program as the user desires at any given time, such as where the program consists of a series of installments and the user wishes to view one or more installments at a sitting. The method then proceeds to 514. Likewise, if it is determined that prior viewing of the audiovisual content has not been initiated by the viewer, the method proceeds to 510 where viewing starts at the beginning of the audiovisual content. Likewise, the viewer can elect to initiate viewing at the beginning for a program that the user has initially began, but not finished. The method then proceeds to 514.

At 514 a stop command is received. The stop command can include a stop command received at the end of a program, when the user is finished with viewing the program content for the time being, or other stop commands. The method then proceeds to 516.

At 516 it is determined whether the end of the audiovisual content has been reached. If the end has not been reached, the method proceeds to 518, where an end-point is stored. The method then proceeds to 520. Likewise, if the end has been reached at 516, the method then proceeds directly to 520.

At 520 the user is billed for the time spent viewing the program. In one exemplary embodiment, the user can be billed at different rates depending on when the user stops viewing the audiovisual content. For example, the user can receive a free preview of the initial audiovisual content, and then can be charged at increasing rates as the audiovisual content progresses. Other suitable billing formats and structures can be used.

In operation, method 500 allows the user to pay for audiovisual content as the user views it. In this manner, various incentives can be created to allow users to watch initial installments for free and then pay for additional installments, to allow viewers to watch installments for free after watching a predetermined number of installments, or to use other suitable pay-as-you-go billing structures.

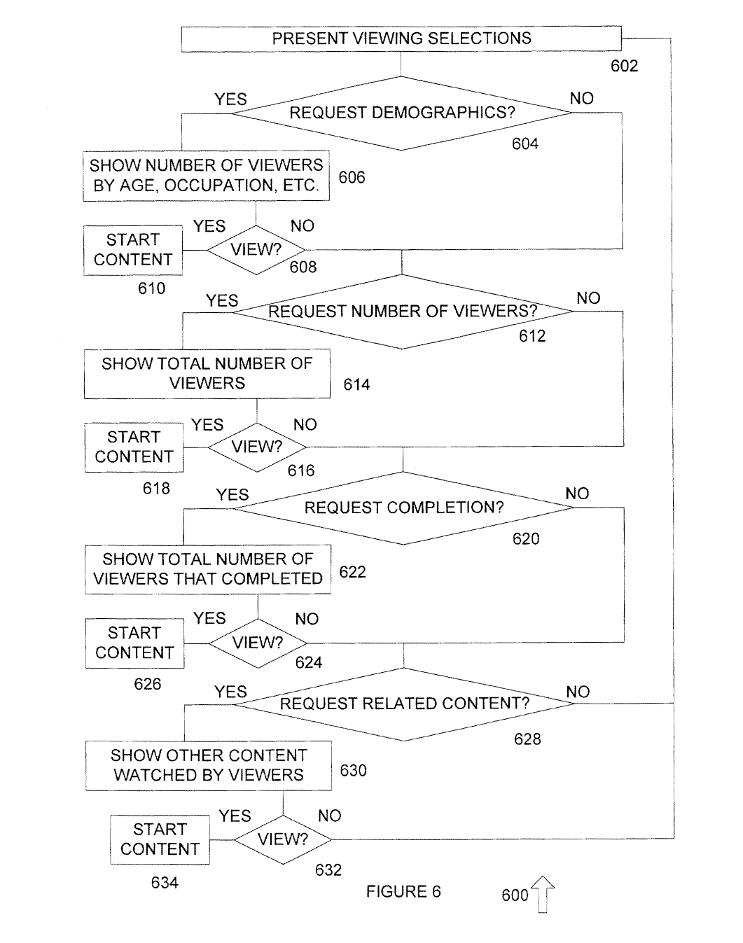

FIG. 6 is a flowchart of a method 600 for allowing a user to select content in accordance with an exemplary embodiment of the present invention.

Method 600 begins at 602 where viewing selections are presented. In one exemplary embodiment, the user can be presented with a main menu that allows the user to select genres, actors, types of sports, producers, or other suitable selections. In another exemplary embodiment, the user can be provided with content suggestions, such as by using a neural network or other suitable systems that select content of potential interest based on content previously viewed by the user, user demographics, content viewed by other users having related demographics, data-mined relationships between viewer demographics and viewed content, and other suitable data. The method then proceeds to 604.

At 604 it is determined whether the user has requested demographic data on the viewing selections. If the user has not requested demographic data, the method proceeds to 612. Otherwise, the method proceeds to 606 where the number of viewers of the viewing selections is shown by age, occupation, time of day that the content was viewed, part of the country that the viewers live, or other suitable demographic data. Likewise, the user can be prompted to select a particular demographic and can be shown leading viewing selections for that demographic. In this exemplary embodiment, a user can be requested to enter an age group, and can be shown the leading programs for viewing by members of that age group. Other suitable demographic selection techniques can be implemented. The method then proceeds to 608.

At 608 it is determined whether the user has selected the audiovisual content for viewing. If the user has selected the content, the method proceeds to 610 where the audiovisual content is started. Otherwise, the method proceeds to 612.

At 612 it is determined whether the number of viewers has been requested. If the number of viewers has not been requested at 612, the method proceeds to 620. Otherwise, the method proceeds to 614 where the total number of viewers for content is shown. In one exemplary embodiment, a viewer may request the total number of viewers that have seen various types of program content, such as game shows, movies, sitcoms, sporting events, or other suitable numbers of viewers. Likewise, the viewer can request the number of viewers for demographic groups or according to other suitable classification schemes. The method then proceeds to 616.

At 616 it is determined whether the user wishes to view the content selection. If the user wishes to view a content selection, the method proceeds to 618 where the content viewing is initiated. Otherwise, the method proceeds to 620.

At 620 it is determined whether the user has requested completion statistics for the content. If the user has not requested completion statistics, the method proceeds to 628. Otherwise, the method proceeds to 622 where the total number of viewers that have completed viewing of each viewing selection is shown. In one exemplary embodiment, the percentage of viewers that initiated viewing a selection that viewed it to completion can be shown (e.g. 60% of the viewers that initiated viewing a selection viewed it to completion). Other suitable completion statistics can be provided. The method then proceeds to 624.

At 624 it is determined whether the user has selected the audiovisual content for viewing. If the user has selected the audiovisual content, the method proceeds to 626 where the audiovisual content provision is started. Otherwise, the method proceeds to 628.

At 628 it is determined whether the viewer has requested related content statistics for an audiovisual selection. If the user has not requested related content, the method returns to 602. Otherwise, the method proceeds 630 where other content that has been watched by viewers of the selected audiovisual content is presented to the viewer. In one exemplary embodiment, the viewer may select a particular audiovisual content selection, such as a movie, a sporting event, a sitcom, or other suitable content. The user can then be presented with the number of viewers that have viewed other related content. In one exemplary embodiment, a user selects a certain movie. The user can be provided with the names of other movies that have been viewed most frequently by other viewers of that selected movie. The method then proceeds to 632.

At 632 it is determined whether the user has selected additional audiovisual content for viewing. If the user has selected either the selection audiovisual content or one of the related audiovisual content programs, the method proceeds to 634 where the audiovisual content is provided to the user. Otherwise, the method returns to 602.

In operation, method 600 allows a user to select audiovisual content based on the demographics of persons that view audiovisual content, the number of people who have viewed the audiovisual content, the number of persons that have viewed the audiovisual content to completion, related audiovisual content viewed by those persons, or other suitable criteria. Method 600 thus allows a user to select audiovisual content when the audiovisual content is not being provided in a program format that provides limited selection ability to the user.

Although exemplary embodiments of a system and method for delivering audiovisual content have been described in detail herein, those skilled in the art will also recognize that various substitutions and modifications can be made to the systems and methods without departing from the scope and spirit of the appended claims.

1-20. (canceled)

21. A method performed by a content service for generating revenue from supplied content without establishing contracts with, or receiving payments from, a plurality of consumers, the content service linking one or more content providers to one or more network operators that use the content service to supply content to the consumers via one or more respective networks, the method comprising:
using at least one computer to perform the steps of:
licensing the content from the one or more content providers;
allowing the consumers to select content available from the one or more content providers;
directly supplying the selected content to the consumers via the one or more respective networks of the one or more network operators without the content service or the one or more content providers charging the consumers;
charging the one or more network operators for the content supplied to the consumers through the one or more respective networks; and
forwarding a portion of payments received from the one or more network operators for the supplied content to the content provider that licensed the supplied content to the content service.

22. The method according to claim 21, further comprising the steps of:
automatically generating a content playlist comprising recommended content items for a consumer; and
allowing the consumer to select content from the content playlist.

23. The method of claim 22, further comprising: tailoring the content playlist to the consumer based on a profile of the consumer, the profile being managed by the content service based on like/dislike indications by the consumer for particular content items in the content playlist.

24. The method according to claim 21, wherein at least one network operator offers the content service to consumers that subscribe to the content service with the network operator.

25. The method according to claim 21, wherein at least one network operator offers said content service and is allowed to send a predetermined amount of content within said content service to a consumer for a payment of a regular subscription fee.

26. The method according to claim 21, wherein at least one network operator offers said content service and is allowed to send content within said content service to a consumer for a payment of a content based fee.

27. The method according to claim 21, wherein the content is provided as a streaming and/or download service to the consumers.

28. The method according to claim 21, wherein least one content provider receives royalties based on time of streaming content used by a consumer.

29. The method according to claim 21, wherein the content service provided to the consumers comprises at least one of a telephone, internet and broadcast service.

30. The method according to claim 21, wherein the content comprises audiovisual content.

31. The method according to claim 21, further comprising the step of providing a content access client that allows the usage of the content service by the consumers.

32. The method of claim 31, wherein allowing the consumers to select content comprises allowing the consumers to select the content using the content access client.

33. The method of claim 21, wherein directly supplying the selected content to the consumers comprises supplying the content without the network operator having to perform any processing steps other than the provision of a channel for communication between the consumer and the content service.

34. The method of claim 21, further comprising: allowing the one or more network operators to directly charge the consumers without involving the content service.

35. The method of claim 21, wherein at least one network operator does not charge a consumer for the content supplied to the consumer.

36. The method of claim 21, wherein the one or more network operators comprise one or more operators selected from the group comprising a mobile telephone carrier, a wire based telephone operator, a television broadcaster, and an internet provider.

37. The method of claim 21, wherein allowing the consumers to select content comprises receiving a consumer selection from a content access device associated with a particular consumer.

38. The method of claim 21, wherein the one or more respective networks comprise one or more networks selected from the group comprising a computer network, a telephone network, a mobile telephone network, the internet, a wireless network, and a broadcast television network.

39. The method of claim 21, wherein the payments received from the one or more network operators are received in advance of the one or more network operators receiving payments from the consumers.
